(19) United States
(12) Patent Application Publication
(10) Pub. No.: US 2005/0281500 A1
(43) Pub. Date: Dec. 22, 2005

(54) Enclosed ball bearing that automatically compensates lubricant

(76) Inventor: Hon-Yue Lin, Tai Nan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/869,426

(22) Filed: Jun. 16, 2004

(51) Int. Cl. F16C 19/00

(52) U.S. Cl. 384/475

(57) ABSTRACT

An enclosed ball bearing is disclosed to include a bearing, which defines a holding space sealed in between the outer race and inner race thereof by seal members and which has balls mounted in the holding space and supported between the outer race and the inner race for relative rotation between the outer race and the inner and a through hole extended through the periphery of the outer race in communication with the holding space, and a socket mounted on the outer side of the bearing and defining with the bearing an enclosed lubricant space that accommodates a lubricant that is movable through the through hole into the holding space of the bearing to lubricate the balls.

### BACKGROUND OF THE INVENTION

1. Field of the Invention

The present invention relates to enclosed ball bearings and more particularly, to such an enclosed ball bearing that automatically compensates lubricant.

2. Description of the Related Art

In industry, ball bearings are commonly and intensively used, for example, used in products such as electric fans, roller-skates, cars and motorcycles, and etc, for relative rotation between parts. A bearing of a car or the like produces a high temperature when bearing a heavy load. After a long use, the lubricant of a bearing may be evaporated or hardened and may leak under different working environments, thereby causing the bearing to get stuck or burned out. When changing a bearing, many related parts must be dismantled. Therefore, it requires much time and labor to replace a bearing, and the related maintenance cost is high. A severe damage of the bearing may cause the shaft to break due to overheat, resulting in an accident.

FIGS. 1A and 1B show an enclosed ball bearing constructed according to the prior art. According to this design, the balls 3 are mounted in between the outer race 1 and the inner race 2, and a cage 4 is provided between each two adjacent balls 3 to prevent friction between the balls 3. Further, a cover shell 5 is provided between the outer race 1 and the inner race 2 to enclose the balls 3. According to this design, the holding space inside the enclosed ball bearing for lubricant is fixed. After a long use of the enclosed ball bearing, the lubricant may leak, or may be evaporated or hardened, resulting in poor lubrication to the balls. Insufficient lubrication to the balls causes a high temperature and noise during operation of the enclosed ball bearing, and the enclosed ball bearing may get stuck. A damage of the enclosed ball bearing may cause the shaft to break, resulting in an accident against public safety. In order to prevent the occurrence of an accident due to damage of an enclosed ball bearing, the enclosed ball bearing must be frequently replaced with a new one. However, it takes much time and labor to replace the enclosed ball bearing frequently.

Therefore, it is desirable to provide an enclosed ball bearing that eliminates the aforesaid problems.

### SUMMARY OF THE INVENTION

The present invention has been accomplished under the circumstances in view. It is therefore the main object of the present invention to provide an enclosed ball bearing, which automatically compensates lubricant so that the service life and durability of the bearing are greatly prolonged and, which has industrial value and is non-obvious.

According to the present invention, two lubricant grooves are provided, forming an enclosed lubricant space in between the socket and the outer race of the bearing to accommodate a lubricant. When the working temperature of the bearing is increasing the lubricant in the lubricant grooves is heated to expand and to further move through the radial through hole into the holding space of the bearing to increase the amount of the lubricant in the holding space, enhancing the lubrication effect to the balls. When the working temperature of the bearing is reducing, the lubricant shrinks and moves backwards from the holding space through the radial through hole into the enclosed lubricant space formed of the lubricant grooves, and therefore the amount of the lubricant in the holding space returns normal. Therefore, the lubricant moves through the radial through hole between the holding space and the enclosed lubricant space formed of the lubricant grooves subject to the variation of the working temperature of the bearing.

### BRIEF DESCRIPTION OF THE DRAWINGS

FIG. 1A is a sectional front view of an enclosed ball bearing according to the prior art.

FIG. 1B is a sectional side view of the enclosed ball bearing according to the prior art.

FIG. 2 is a sectional elevation of an enclosed ball bearing according to the first embodiment of the present invention.

FIG. 3 is an exploded view of the enclosed ball bearing according to the first embodiment of the present invention.

FIG. 4A is a sectional view taken along line B-B of FIG. 2.

FIG. 4B is a sectional view taken along line A-A of FIG. 2.

FIG. 5 is a schematic drawing showing an operation status of the enclosed ball bearing according to the first embodiment of the present invention.

FIG. 6A is a sectional front view of an enclosed ball bearing according to the second embodiment of the present invention.

FIG. 6B is a sectional side view of the enclosed ball bearing according to the second embodiment of the present invention.

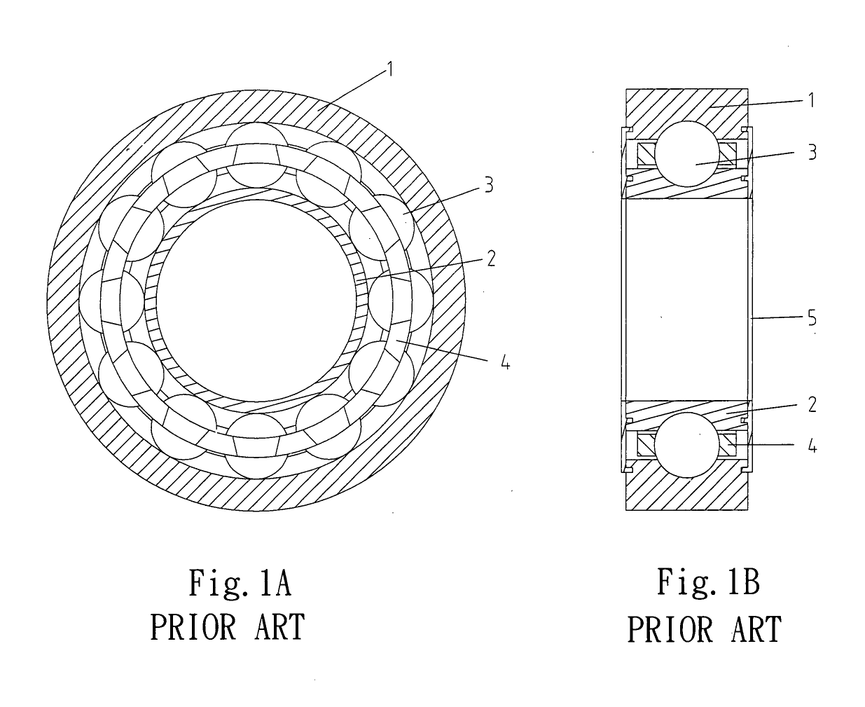

### DETAILED DESCRIPTION OF THE PREFERRED EMBODIMENT

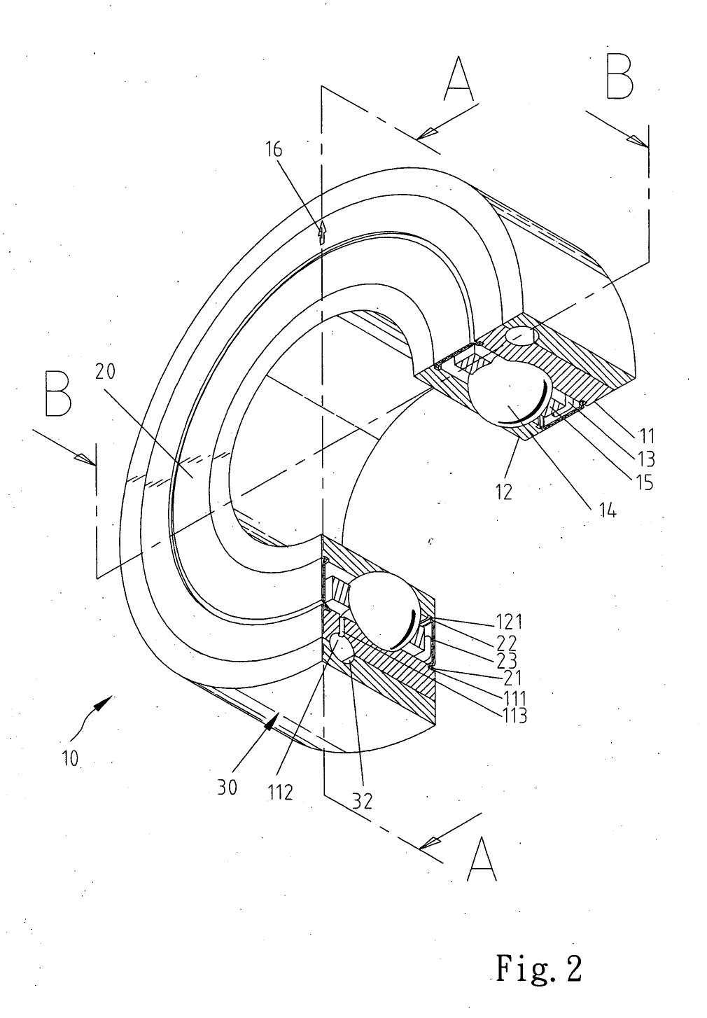

FIGS. 2-6 show two different alternate forms of enclosed ball bearing according to the present invention. However, the invention is not limited to the embodiments disclosed.

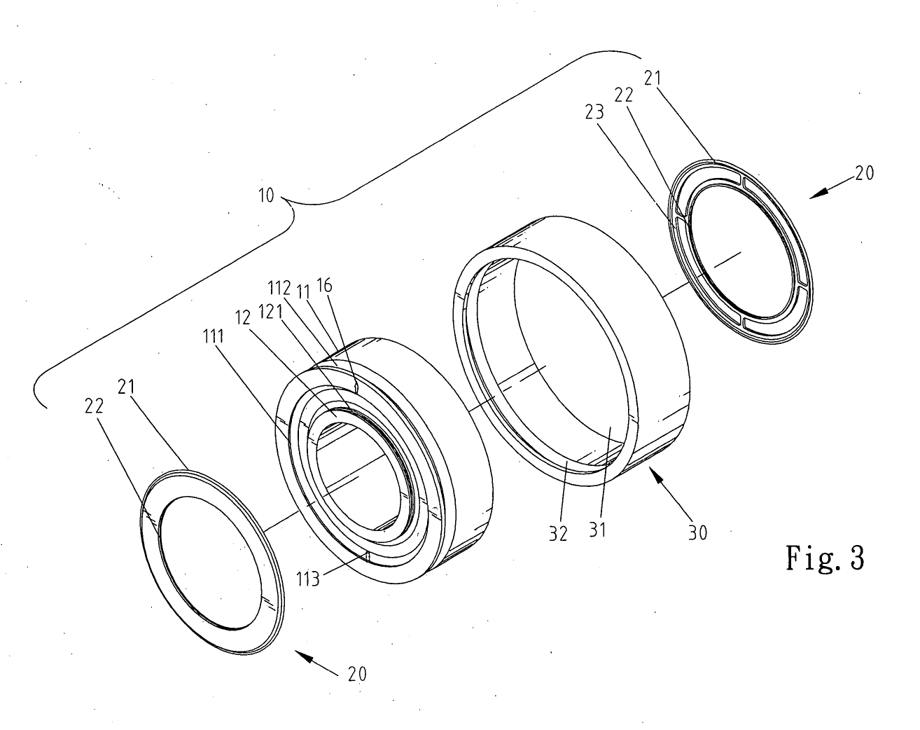

Referring to FIGS. 2 and 3, an enclosed ball bearing that automatically compensates lubricating oil in accordance with the first embodiment of the present invention is shown comprised of a bearing 10, two seal members 20, and a socket 30.

The bearing 10 comprises an outer race 11 and an inner race 12. The outer race 11 and the inner race 12 are joined together, defining a holding space 13 that accommodates balls 14. As shown in FIG. 2, cage means 15 is set in the holding space 13 to prevent friction between balls 14. As shown in FIG. 3, locating grooves 111, 121 are respectively formed in the outer race 11 and the inner race 12 at two sides. The outer race 11 further has a lubricant groove 112 extended around the periphery and spaced from the midpoint of the periphery at a distance, and a radial through hole 113 cut through the periphery in communication between the lubricant groove 112 and the holding space 13.

The seal members 20 are annular members made of elastic material, each having an outer locating flange 21 extended around the outer diameter for engaging the locating groove 111 at one side of the outer race 11, an inner locating flange 22 extended around the inner diameter for engaging the locating groove 121 at one side of the inner race 12, and a hollow metal packing element 23 provided at the inner side between the outer locating flange 21 and the inner locating flange 22 (the metal packing element used in the seal member according to the prior art is a solid member). Because the metal packing elements 23 have a hollow structure, the seal members 20 are relatively springy than the prior art design.

The socket 30 defines a receiving space 31, which accommodates the bearing 10, and has a lubricant groove 32 extended around the inside wall corresponding to the lubricant groove 112 of the outer race 11 of the bearing 10. After setting of the bearing 10 in the receiving space 31 inside the socket 30, the lubricant grooves 32, 112 form an enclosed lubricant space for holding a lubricant. The sizes of the inner and outer diameters of the present invention fit standard bearing specifications.

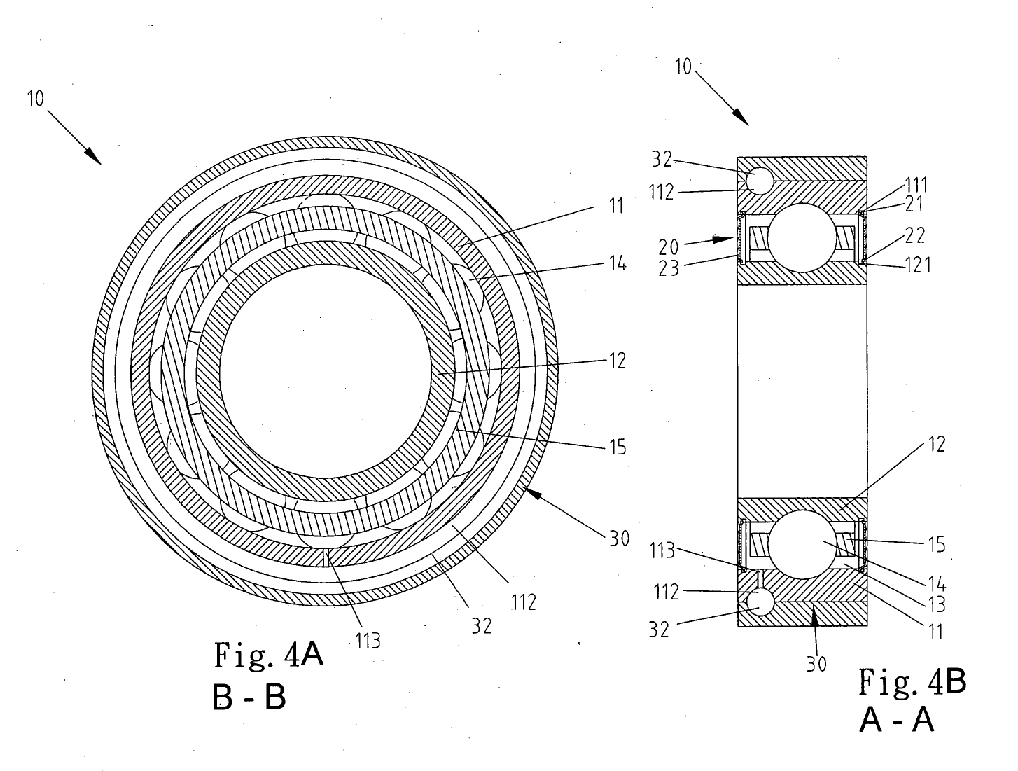

Referring to FIGS. 4A and 4B, during installation of the enclosed ball bearing, the radial through hole 113 that communicates the lubricant groove 112 and the holding space 13 is set to the bottom side. Because the lubricant expands when hot, or shrinks when cold, it is necessary to set the radial through hole 113 to the bottom side so that the lubricant can expand and move upward into the holding space 13 when hot, or shrink and move downwardly backwards to the lubricant groove 32, 112 when cold. A mark 16 may be marked on the bearing 10 for recognition. Referring to FIG. 2 again, the press-fitting engagement between the outer locating flanges 21 and inner locating flanges 22 of the seal members 20 and the locating grooves 111 of the outer race 11 and the locating grooves 121 of the inner race 12 greatly improves the sealing power between the seal members 20 and the bearing 10, preventing leakage of the lubricant in the holding space 13. Because the lubricant groove 112 is an eccentric design, the presence of the lubricant groove 112 does not affect the structural strength of the bearing 10. Because the metal packing elements 23 have a hollow structure, the seal members 20 are springy and capable of absorbing the dynamic saturation micro pressure produced by the lubricant in the holding space 13, preventing leakage of the lubricant due to the presence of pressure.

As indicated above, the lubricant grooves 32, 112 form an enclosed lubricant space between the socket 30 and the outer race 11 of the bearing 10 for accommodating the lubricant, enabling the lubricant to pass through the radial through hole 113 into the holding space 13 of the bearing 10 to lubricate the balls 14. When the working temperature of the bearing 10 is increasing, the lubricant in the lubricant grooves 32, 112 is heated to expand and to further move through the radial through hole 113 into the holding space 13 of the bearing 10 to increase the amount of the lubricant in the holding space 13, enhancing the lubrication effect to the balls 14. On the contrary, when the working temperature of the bearing 10 is reducing, the lubricant shrinks and moves backwards from the holding space 13 through the radial through hole 113 into the enclosed lubricant space formed of the lubricant grooves 32, 112, and therefore the amount of the lubricant in the holding space 13 returns normal. The aforesaid action is repeated so that the lubricant moves through the radial through hole 113 between the holding space 13 and the enclosed lubricant space formed of the lubricant grooves 32, 112 subject to the variation of the working temperature of the bearing 10. Therefore, the balls 14 in the bearing 10 are lubricated efficiently, preventing high noise and high temperature during operation or sticking of the bearing due to insufficient lubrication. Therefore, the service life of the enclosed ball bearing of the present invention is greatly prolonged. In conclusion, the enclosed ball bearing of the invention has an economic value, and this design greatly lowers the frequency of replacing the bearing.

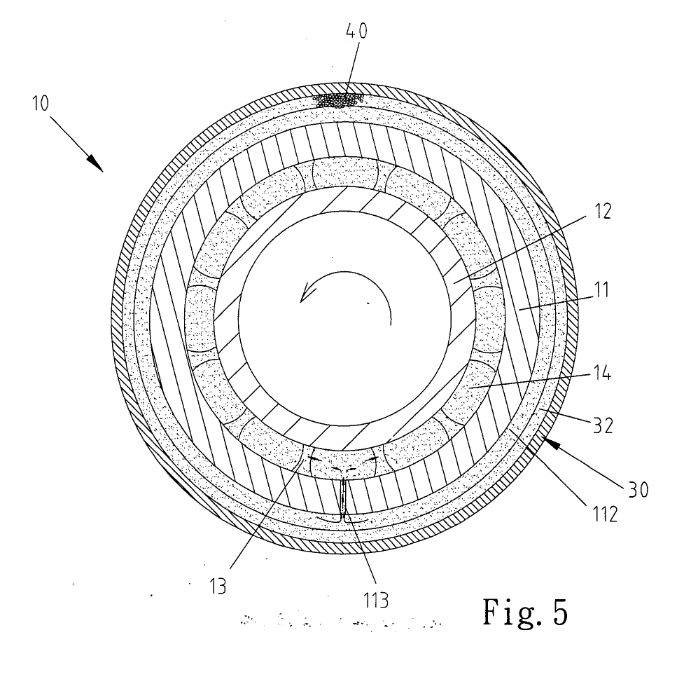

Referring to FIG. 5, after a long use of the enclosed ball bearing, air bubbles 40 may be produced in the lubricant and gathered in the top side of the enclosed lubricant space formed of the lubricant grooves 32, 112. The presence of the air bubbles 40 does no harm and is good to the operation of the enclosed ball bearing. Because the space for the air bubbles 40 has displaced the space for the lubricant, the total amount of usable lubricant is relatively increased. The amount of the displacement is a part of the standby lubricant.

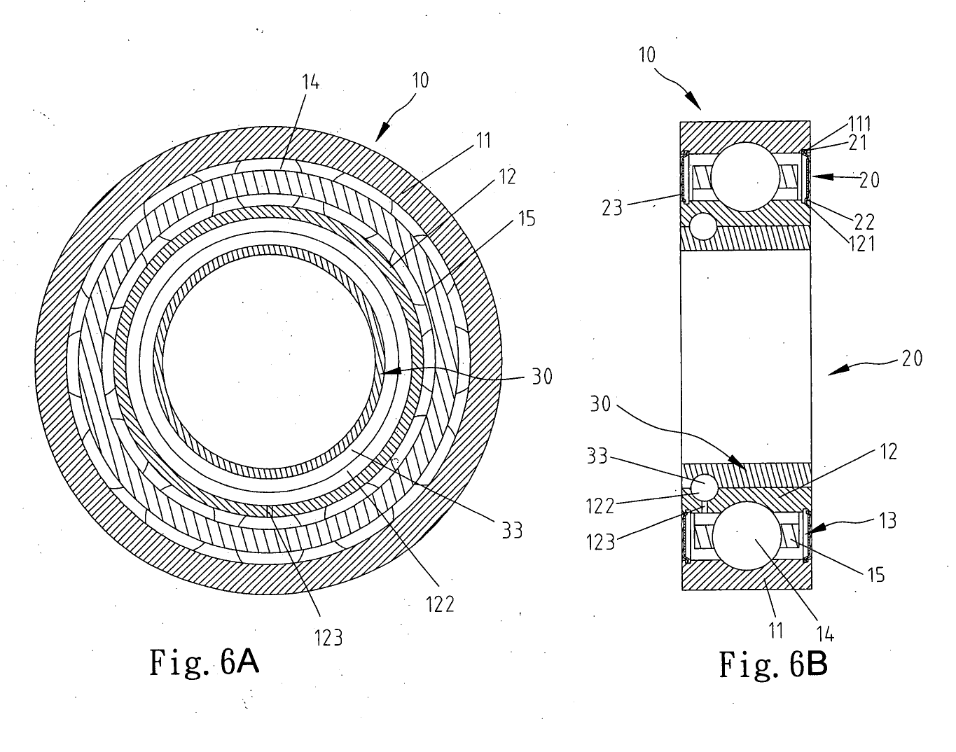

FIGS. 6A and 6B show an enclosed ball bearing constructed according to the second embodiment of the present invention This second embodiment is substantially similar to the aforesaid first embodiment, and therefore like reference sings are used to indicate like members. According to this embodiment, the socket 30 is mounted within the inner race 12 of the bearing 10, having a lubricant groove 33 extended around the periphery and a radial through hole 123 adapted to communicate the lubricant groove 33 with the holding space 13 of the bearing 10. After installation of the socket 30 in the inner race 12 of the bearing 10, the lubricant groove 33 forms an enclosed lubricant space that accommodates the lubricant. The sizes of the inner and outer diameters of this second embodiment fit standard bearing specifications. This second embodiment achieves the same effects as the aforesaid first embodiment does.

As described above, the enclosed ball bearing that automatically compensates lubricant shows better effects than conventional designs and, has an industrial value. The advantages of the enclosed ball bearing are numerous and outlined hereinafter:

1. Two lubricant grooves are provided, forming an enclosed lubricant space in between the socket and the outer race of the bearing to accommodate a lubricant. When the working temperature of the bearing is increasing the lubricant in the lubricant grooves is heated to expand and to further move through the radial through hole into the holding space of the bearing to increase the amount of the lubricant in the holding space, enhancing the lubrication effect to the balls. When the working temperature of the bearing is reducing, the lubricant shrinks and moves backwards from the holding space through the radial through hole into the enclosed lubricant space formed of the lubricant grooves, and therefore the amount of the lubricant in the holding space returns normal. Therefore, the lubricant moves through the radial through hole between the holding space and the enclosed lubricant space formed of the lubricant grooves subject to the variation of the working temperature of the bearing.

2. The enclosed ball bearing has the function of automatically compensating the lubricant, and the lubricant held in the lubricant grooves is repeatedly used. Because the balls in the bearing are constantly well lubricated, the bearing does not produce much heat or noise and will never get stuck during operation. Therefore, the service life of the enclosed ball bearing of the present invention is greatly prolonged, and the frequency of replacement of bearing is greatly lowered. The simple structure of the enclosed ball bearing is satisfactory in function. It is indeed an economically valuable design.

3. The press-fitting engagement between the outer locating flanges and inner locating flanges of the seal members and the locating grooves of the outer and inner races greatly improves the sealing power between the seal members and the bearing, preventing leakage of the lubricant in the holding space.

4. The metal packing elements have a hollow structure, therefore the seal members are springy and capable of absorbing the dynamic saturation micro pressure produced by the lubricant in the holding space, preventing leakage of the lubricant due to the presence of pressure.

A prototype of enclosed ball bearing has been constructed with the features of FIGS. 2-6. The enclosed ball bearing functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. An enclosed ball bearing comprising:
a bearing, said bearing comprising an outer race, an inner race, a holding space defined in between said outer race and said inner race, seal members disposed at two sides to close said holding space in a watertight status, a plurality of balls mounted in said holding space and supported between said outer race and said inner race for enabling said outer race and said inner race to be rotated relative to each other, and at least one through hole extended through the periphery of said outer race in communication with said holding space; and
at least one socket mounted on an outer side of said bearing and defining with said bearing an enclosed lubricant space that accommodates a lubricant that is movable through said through hole into the holding space of said bearing to lubricate said balls.

2. The enclosed ball bearing comprising:
a bearing, said bearing comprising an outer race, an inner race, a holding space defined in between said outer race and said inner race, a plurality of balls mounted in said holding space and supported between said outer race and said inner race for enabling said outer race and said inner race to be rotated relative to each other, and at least one through hole extended through the periphery of said outer race in communication with said holding space;
at least one socket mounted on said bearing and defining with said bearing an enclosed lubricant space that accommodates a lubricant that is movable through said through hole into the holding space of said bearing to lubricate said balls; and
at least two seal members fastened to said bearing at two sides to close said holding space in a watertight status, each said seal member having a hollow metal packing element provided at an inner side, said at least two seal members being springy for absorbing dynamic saturation micro pressure produced by said lubricant in said holding space to prevent leakage of said lubricant due to the presence of pressure.

3. An enclosed ball bearing comprising:
a bearing, said bearing comprising an outer race, an inner race, a holding space defined in between said outer race and said inner race, seal means disposed at two sides to close said holding space in a watertight status, a plurality of balls mounted in said holding space and supported between said outer race and said inner race for enabling said outer race and said inner race to be rotated relative to each other, and at least one through hole extended through the periphery of said outer race in communication with said holding space; and
at least one socket mounted inside said bearing and defining with said bearing an enclosed lubricant space that accommodates a lubricant that is movable through said through hole into the holding space of said bearing to lubricate said balls.

4. The enclosed ball bearing as claimed in claim 3, wherein said bearing further comprises cage means that prevents friction between said balls.

5. The enclosed ball bearing as claimed in claim 2, wherein said outer race and said inner race each have at least one locating groove at each side; said seal members each have at least one locating flange respectively press-fitted into the locating grooves of said outer race and said inner race.

6. The enclosed ball bearing as claimed in claim 2, wherein said outer race has at least one lubricant groove extended around the periphery and disposed in communication with said holding space via said at least one through hole.

7. The enclosed ball bearing as claimed in claim 6, wherein said socket comprises a lubricant groove, which defines with the at least one lubricant groove of said outer race said enclosed lubricant space after mounting of said socket on said bearing.

8. The enclosed ball bearing as claimed in claim 3, wherein said inner race has at least one lubricant groove extended around the periphery thereof and disposed in communication with said holding space via said at least one through hole.

9. The enclosed ball bearing as claimed in claim 8, wherein said socket comprises a lubricant groove, which defines with the at least one lubricant groove of said inner race said enclosed lubricant space after mounting of said socket on said bearing.

10. The enclosed ball bearing as claimed in claim 1, wherein said bearing further comprises cage means that prevents friction between said balls.

11. The enclosed ball bearing as claimed in claim 2, wherein said bearing further comprises cage means that prevents friction between said balls.

12. The enclosed ball bearing as claimed in claim 1, wherein said outer race and said inner race each have at least one locating groove at each side; said seal members each have at least one locating flange respectively press-fitted into the locating grooves of said outer race and said inner race.

13. The enclosed ball bearing as claimed in claim 1, wherein said outer race has at least one lubricant groove extended around the periphery and disposed in communication with said holding space via said at least one through hole.

14. The enclosed ball bearing as claimed in claim 13, wherein said socket comprises a lubricant groove, which defines with the at least one lubricant groove of said outer race said enclosed lubricant space after mounting of said socket on said bearing.
